(19) United States
(12) Patent Application Publication
(10) Pub. No.: US 2020/0408279 A1
(43) Pub. Date: Dec. 31, 2020

(54) PINION AND POWER TRANSMISSION DEVICE

(71) Applicant: KAMOSEIKO KABUSHIKI KAISHA, Toyota-shi (JP)

(72) Inventors: Yoshitake KATAYAMA, Toyota-shi (JP); Yusuke FUKUOKA, Toyota-shi (JP); Ikuyo YOSHIDA, Toyota-shi (JP)

(73) Assignee: KAMOSEIKO KABUSHIKI KAISHA, Toyota-shi (JP)

(21) Appl. No.: 16/692,324

(22) Filed: Nov. 22, 2019

(30) Foreign Application Priority Data
Jun. 28, 2019 (JP) 2019-122328

(51) Int. Cl. F16H 1/04; F16H 61/688

(52) U.S. Cl. CPC F16H 1/04; F16H 2019/046; F16H 61/688

(57) ABSTRACT

A pinion (1) including a pin gear allows easy engagement with or disengagement from a mating gear. The pinion (1) includes a plurality of pins (2) as teeth, and includes a first plate (4) and a second plate (5) described below. The first plate (4) interconnects first ends of the pins (2). The second plate (5) is spaced from the first plate (4) in the rotation axis direction of the pinion (1), and interconnects second ends of the pins (2). The second plate (5) has, on its outer peripheral edge, recesses (15, 16) each between two pins (2) adjacent circumferentially. The recesses (15, 16) recede inward from inner circumferential ends of the pins (2). The pinion (1) is moved axially for engagement with or disengagement from the rack (3). The pinion (1) increases flexibility at the time of engagement with or disengagement from a mating gear.

### BACKGROUND

### Technical Field

The present disclosure mainly relates to a pinion.

### Description of the Background

Known transportation apparatuses that use meshing between a rack and a pinion or known decelerators that use meshing between gears may include pin gears as pinions (refer to, for example, Patent Literatures 1 and 2). Further, pin gears used as pinions have been improved variously to increase stability and quietness during operation (refer to, for example, Patent Literature 3).

A pin gear described in Patent Literature 3 includes a plate holding the ends of pins and receiving bearings (described below). More specifically, the plate has circular holes for receiving the pin ends and the bearings. Each bearing includes needle rollers arranged cylindrically and a retainer retaining the needle rollers. Inside each circular hole, the pin end is fitted along the inner circumference of the cylinder defined by the needle rollers. The needle rollers are thus in contact with the outer circumference of the pin roller to support the pin roller.

The structure described in Patent Literature 3 minimizes backlash, and thus greatly improves stability and quietness.

Such pin gears used as pinions are expected to increase flexibility at the time of engagement with or disengagement from the mating gear.

### CITATION LIST

### Patent Literature

Patent Literature 1: Japanese Unexamined Patent Application Publication (Translation of PCT Application) No. 2018-508720
Patent Literature 2: Japanese Unexamined Patent Application Publication (Translation of PCT Application) No. 2014-513253
Patent Literature 3: Japanese Unexamined Patent Application Publication No. 2013-36488

### BRIEF SUMMARY

One or more aspects of the present disclosure are directed to a pinion including a pin gear that increases flexibility at the time of engagement with or disengagement from a mating gear.

A pinion according to an aspect of the present disclosure includes a plurality of pins as teeth, and includes a first plate and a second plate described below. The first plate interconnects first ends of the pins. The second plate is spaced from the first plate in the rotation axis direction of the pinion, and interconnects second ends of the pins. The second plate has, on its outer peripheral edge, recesses each between two pins adjacent circumferentially. The recesses recede inward from outer circumferential ends of the pins.

The pinion according to the aspect of the present disclosure can increase flexibility at the time of engagement with or disengagement from a mating gear.

### BRIEF DESCRIPTION OF DRAWINGS

FIG. 1 is a plan view of a pinion according to a first embodiment.

FIG. 2 is a side view of the pinion according to the first embodiment.

FIG. 3 is a perspective view of the pinion according to the first embodiment.

FIG. 4 is an exploded perspective view of the pinion according to the first embodiment.

FIG. 5 is a cross-sectional view taken along line V-V in FIG. 1 in the first embodiment.

FIG. 6 is a perspective view showing a pinion according to a second embodiment that is meshed with a crown gear.

### DETAILED DESCRIPTION

Embodiments of the present disclosure will now be described in detail below.

### Embodiments

### Structure of First Embodiment

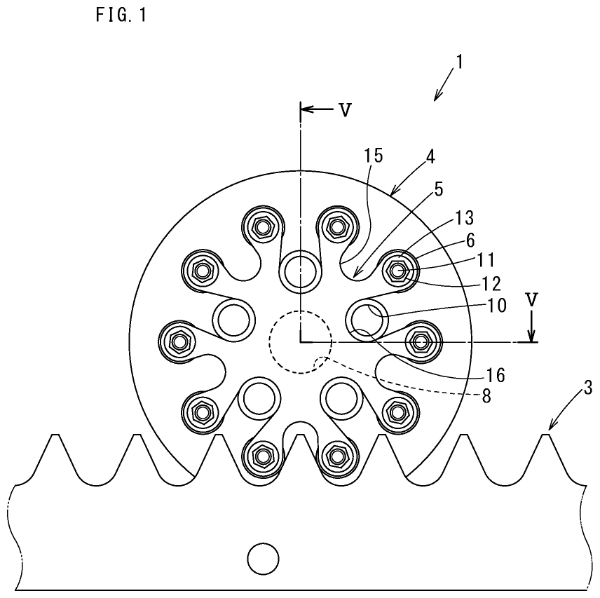

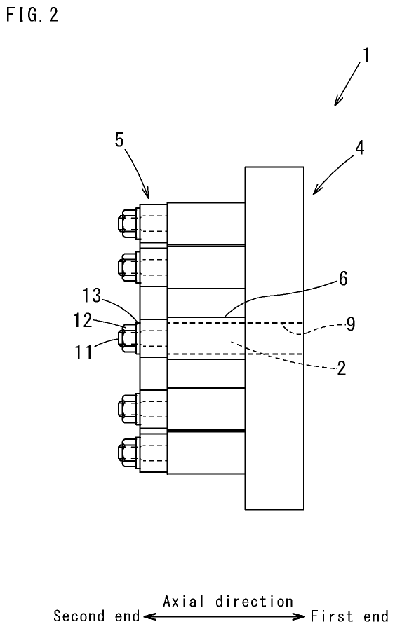

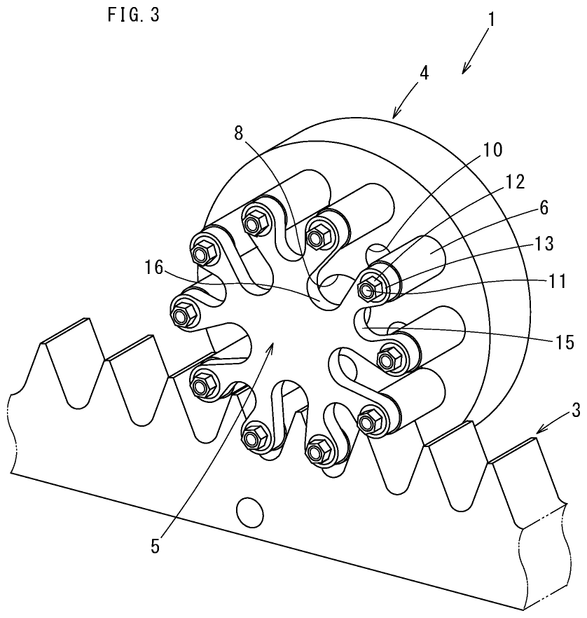

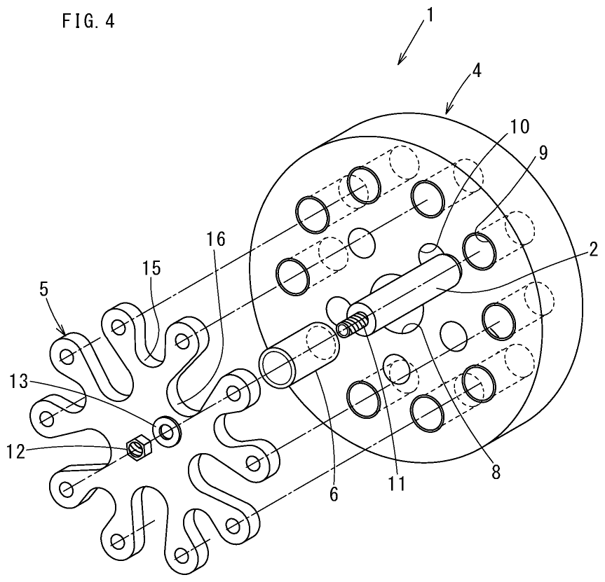

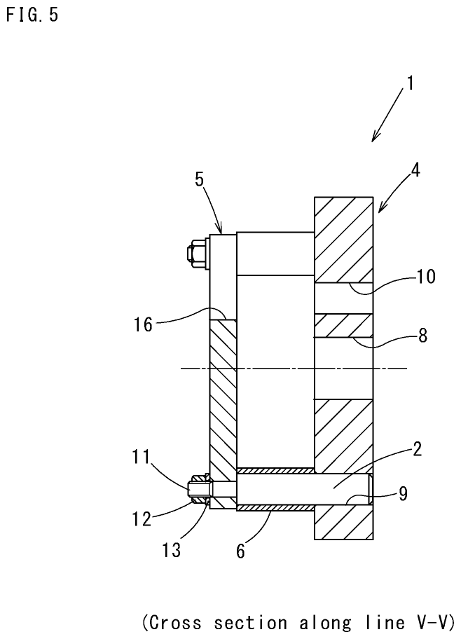

A pinion 1 according to a first embodiment will now be described with reference to FIGS. 1 to 5.

The pinion 1 as a pin gear includes multiple pins 2 as teeth, and is usable in, for example, a rack-and-pinion transportation apparatus in which the pinion 1 is meshed with a rack 3.

The pinion 1 includes a first plate 4, a second plate 5, and cylinders 6, which are described below.

The first plate 4 interconnects first ends of the pins 2. The pins 2 are columnar.

The first plate 4 is a disk having a predetermined thickness in the rotation axis direction of the pinion 1. The first plate 4 has a cylindrical through-hole 8 at its center, which is coaxial with the entire first plate 4. The hole 8 is surrounded by press-fit holes 9 formed at regular angular intervals to receive the first ends of the pins 2. With the first ends press-fitted into the press-fit holes 9, the pins 2 are fixed to the first plate 4.

The first plate 4 further has mounting holes 10 inward from the press-fit holes 9. The mounting holes 10 are through-holes for mounting the pinion 1 onto another component. Each mounting hole 10 is between two pairs of press-fit holes 9 adjacent circumferentially. When, for example, ten pins 2 are to be fitted, five mounting holes 10 are formed. Each pin 2 has, at its axial second end, a threaded shaft 11 for fastening the pin 2 to the second plate 5.

The second plate 5 is spaced from the first plate 4 in the rotation axis direction of the pinion 1, and interconnects the second ends of the pins 2.

The second plate 5 is thinner than the first plate 4 in the axial direction. For example, the second plate 5 has a thickness less than or equal to half the thickness of the first plate 4. The second plate 5 and the cylinders 6 are held between the nuts 12 and the first plate 4 in the axial direction with the nuts 12 screwed onto the shafts 11. A washer 13 is placed between the second plate 5 and each nut 12.

The second plate 5 has, on its outer peripheral edge, recesses 15 and 16 each between two pins 2 adjacent circumferentially. The recesses 15 and 16 recede inward from the inner circumferential ends of the pins 2. The recesses 16 recede more inward than the recesses 15. The recesses 15 and 16 are circumferentially alternate to each other. In the assembled state, the recesses 16 are circumferentially aligned in the same direction as the mounting holes 10. The recesses 15 and 16 recede circumferentially inward, forming a semicircular arc. The second plate 5 protrudes circumferentially outward, on its outer peripheral edge excluding the recesses 15 and 16, thus forming semicircular arcs.

Each cylinder 6 covers an outer circumferential portion of the corresponding pin 2 between the first plate 4 and the second plate 5. The cylinders 6 and the second plate 5 are held between the nuts 12 and the first plate 4 in the axial direction with the nuts 12 screwed onto the shafts 11 as described above. The nuts 12 are screwed onto the shafts 11 to allow the cylinders 6 to rotate freely.

### Features of First Embodiment

The pinion 1 according to the first embodiment includes the pins 2 as teeth, and includes the first plate 4 and the second plate 5 described below. The first plate 4 interconnects the first ends of the pins 2. The second plate 5 is spaced from the first plate 4 in the axial direction, and interconnects the second ends of the pins 2. The second plate 5 has, on its outer peripheral edge, the recesses 15 and 16 each between the two pins 2 adjacent circumferentially. The recesses 15 and 16 recede inward from the inner circumferential ends of the pins 2. Thus, the pinion 1 can be moved axially for engagement with or disengagement from the rack 3. The pinion 1 thus increases flexibility at the time of engagement with or disengagement from a mating gear.

The pinion 1 according to the first embodiment includes the recesses 16 that recede more inward than the recesses 15. The recesses 15 and 16 are circumferentially alternate to each other. In the assembled state, the recesses 16 are circumferentially aligned in the same direction as the mounting holes 10.

The pinion 1 is thus easily mountable onto another device.

The pinion 1 according to the first embodiment further includes the cylinders 6 described below. Each cylinder 6 covers the outer circumferential portion of the corresponding pin 2 between the first plate 4 and the second plate 5.

The pins 2 meshed with the teeth of the rack 3 with the cylinders 6 between them can reduce backlash to substantially the same amount as the structure described in Patent Literature 3 and maintain stability and quietness, without using the bearings used in the structure in Patent Literature 3. This structure can lower the cost of the pinion 1 including a pin gear without degrading the stability and quietness.

The above three features can also be achieved by the pinion 1 without the second plate 5. However, the pinion 1 without the second plate 5 includes the pins 2 with second ends not interconnected by the second plate 5, and can have lower rigidity. The pinion 1 can be highly rigid and thus highly durable when including the second plate 5 that interconnects the second ends of the pins 2.

The recesses 15 and 16 may be formed by laser processing or by punching with a punch press.

### Second Embodiment

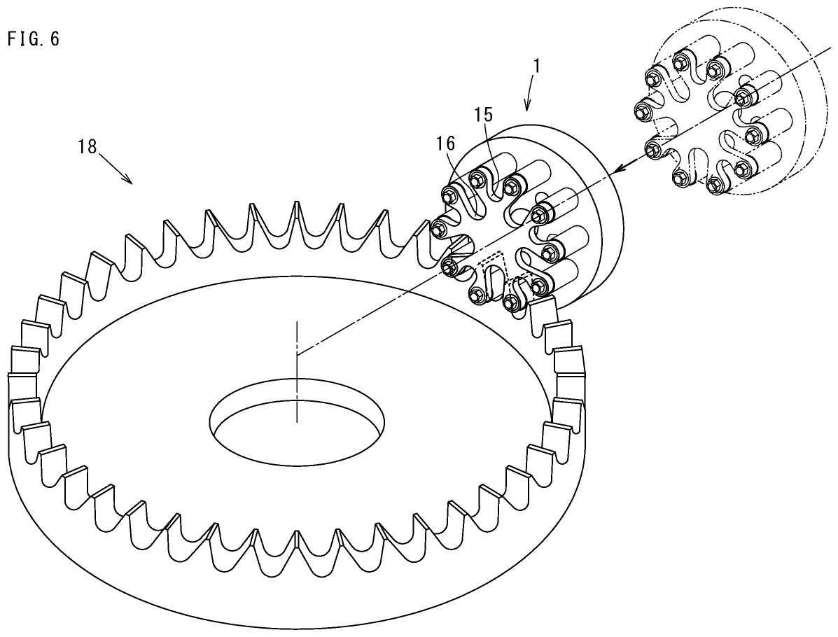

As shown in FIG. 6, a pinion 1 according to a second embodiment is meshed with a crown gear 18 in a power transmission device.

The structure including the pinion 1 meshed with the crown gear 18 provides more distinctive features of the recesses 15 and 16 that allow the pinion 1 to move axially for engagement with or disengagement from a mating gear.

### Modifications

The embodiments may be modified variously without departing from the spirit and scope of the present invention.

For example, although the pinion 1 according to the first or second embodiment includes the cylinders 6 each covering the outer circumferential portion of the corresponding pin 2 between the first plate 4 and the second plate 5, the cylinders 6 may be eliminated, and the pins 2 may be meshed directly with the teeth of the rack 3.

Although the pinion 1 according to the first embodiment is meshed with the rack 3 and the pinion 1 according to the second embodiment is meshed with the crown gear 18, the pinion 1 may be meshed with a gear other than the rack 3 or the crown gear 18.

Further, although the pinion 1 according to the first or second embodiment includes the recesses 15 and 16 that recede more inward than the inner circumferential ends of the pins 2, the pinion 1 is not limited to this structure when the pinion 1 can be moved axially for engagement with or disengagement from a mating gear. In other words, the pinion 1 movable axially for engagement with or disengagement from a mating gear may include recesses 15 and 16 that recede by any degree corresponding to the tooth depth of the rack 3 or the crown gear 18. For example, the recesses 15 may recede between the outer circumferential ends and the inner circumferential ends of the pins 2.

### REFERENCE SIGNS LIST

1 Pinion
2 Pin
4 First plate
5 Second plate
15, 16 Recess

1. A pinion (1) including a plurality of pins (2) as teeth, the pinion (1) comprising:
a first plate (4) interconnecting first ends of the plurality of pins; and
a second plate (5) spaced from the first plate in a rotation axis direction of the pinion, the second plate (5) interconnecting second ends of the plurality of pins,
wherein the second plate includes, on an outer peripheral edge of the second plate, recesses (15, 16) each between two pins adjacent circumferentially, and the recesses recede inward from outer circumferential ends of the pins.

2. The pinion according to claim 1, wherein the recesses include recesses (16) that recede more inward than other recesses (15).

3. The pinion according to claim 1, further comprising: a cylinder (6) covering an outer portion of each pin between the first plate and the second plate.

4. The pinion according to claim 2, further comprising:
a cylinder (6) covering an outer portion of each pin between the first plate and the second plate.

5. A power transmission device, comprising:
a pinion including a plurality of pins as teeth; and
a crown gear meshed with the pinion,
the pinion comprising:
a first plate interconnecting first ends of the plurality of pins; and
a second plate spaced from the first plate in a rotation axis direction of the pinion, the second plate interconnecting second ends of the plurality of pins,
wherein the second plate includes, on an outer peripheral edge of the second plate, recesses each between two pins adjacent circumferentially, and the recesses recede inward from outer circumferential ends of the pins.

6. The power transmission device according to claim 5, wherein
the recesses include recesses (16) that recede more inward than other recesses (15).

7. The power transmission device according to claim 5, further comprising:
a cylinder covering an outer portion of each pin between the first plate and the second plate.

8. The power transmission device according to claim 6, further comprising:
a cylinder covering an outer portion of each pin between the first plate and the second plate.
